(19) United States
(12) Patent Application Publication
(10) Pub. No.: US 2004/0105482 A1
(43) Pub. Date: Jun. 3, 2004

(54) Semiconductor laser apparatus, semiconductor laser control method, and image displaying apparatus

(75) Inventors: Tooru Sugiyama, Kumagaya-shi (JP); Masaki Tsuchida, Fukaya-shi (JP); Nobuaki Kaji, Fukaya-shi (JP); Kiyoyuki Kawai, Kigashikurume-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/665,437

(22) Filed: Sep. 22, 2003

(30) Foreign Application Priority Data
Nov. 29, 2002 (JP) 2002-347506

(51) Int. Cl. H01S 3/08

(52) U.S. Cl. 372/108

(57) ABSTRACT

Rays of light emitted from the semiconductor laser are converted into parallel rays of light by cylindrical lenses. Then, the light passed through the cylindrical lenses is caused to enter an optical fiber changed continuously from a specific position in the middle toward an incidence end part in such a manner that the core shape at the incidence end part becomes elliptic, with the cross-sectional area remaining unchanged.

### CROSS-REFERENCE TO RELATED APPLICATION

This application is based upon and claims the benefit of priority from the prior Japanese Patent Application No. 2002-347506, filed Nov. 29, 2002, the entire contents of which are incorporated herein by reference.

### BACKGROUND OF THE INVENTION

1. Field of the Invention

This invention relates to a semiconductor laser apparatus and a semiconductor laser control method which connect the light emitted from a semiconductor laser to an optical fiber at high efficiency with high light density. This invention also relates to a projection-type image displaying apparatus using the semiconductor laser apparatus as a light source.

2. Description of the Related Art

In recent years, tremendous development effort has been directed toward using a semiconductor laser as a light source for a projection-type image displaying apparatus, such as a liquid-crystal projector.

In this type of image displaying apparatus, the light emitted from the semiconductor laser that generates as high an optical output as several watts to ten watts is caused to enter an optical fiber constituting a fiber laser, thereby producing visible light with high light density to display images.

Generally, a semiconductor laser goes into a multi-mode, when generating a high output, and has a long, narrow emitting region. For example, the emitting region of a semiconductor laser that generates a 1-W output is 100 μm long in the slow axis direction and 1 μm long in the fast axis direction.

The light emitted from such a semiconductor laser is radiated, for example, with a divergence angle of ±40 in the slow axis direction and ±200 in the fast axis direction with respect to the optical axis perpendicular to the emitting region surface.

It is assumed that the light-receiving angle of the optical fiber which the emitted light from the semiconductor laser is caused to enter is symmetry with respect to the optical axis and is 200 in both of the slow axis direction and the fast axis direction.

When the emitted light from the semiconductor laser is adjusted via a lens to the light-receiving angle of the optical fiber, the beam diameter fulfills a sine condition (the relationship between the beam diameter D and the divergence angle θ: Dsin θ=constant). Consequently, the beam diameter is 40 μm long in the slow axis direction and 2 μm long in the fast axis direction and therefore is in the form of a long, narrow shape.

Since the core cross-sectional shape of the optical fiber is generally circular, a core diameter of 40 μm is necessary to cause all the light with such a long, narrow beam diameter to enter the optical fiber.

With such a core diameter, all the light emitted from the semiconductor laser can be caused to enter the optical fiber. However, because the light enters the optical fiber with a good margin in the fast axis direction, the light density (incident light power/optical fiber core cross-sectional area of the incident light decreases. Specifically, to project light with a high light density, it is desirable that the core cross-sectional shape of the optical fiber should be equal to the beam diameter.

U.S. Pat. No. 5,677,920 has disclosed an example where the cross-sectional shape of the inner clad to which excitation light is inputted is made rectangular in a double clad fiber used in an optical fiber laser.

However, the following problem arises: not only an optical fiber whose core cross section is rectangular is very difficult to manufacture, but also an ordinary optical fiber whose cross section is circular cannot be connected easily to an optical fiber whose cross section is rectangular.

Patent document 1 has also disclosed an example of stacking a plurality of optical fibers whose cross section is rectangular one on top of another and optically connecting the resulting fiber to another optical fiber, taking into account a case where a plurality of optical fiber outputs are combined and the resulting output is optically connected to another optical fiber.

This approach, however, requires not only a high-degree of alignment when stacking optical fibers one on top of another but also the designing of the resulting optical fiber according to the shape of the optical fiber to which the former is to be connected. Therefore, the configuration cannot be said to be practical.

As described above, when an optical fiber whose core cross-sectional shape is circular is used, it has been difficult to cause the light emitted from a multi-mode semiconductor laser to enter an optical fiber at high efficiency with high light density.

Furthermore, when an optical fiber whose core cross-sectional shape is rectangular is used, the following problem arises: such an optical fiber is not only difficult to manufacture but also impossible to connect easily to an ordinary optical fiber whose cross section is round.

In addition, when a plurality of optical fibers whose core cross-sectional shape is rectangular are combined and the resulting optical fiber is connected optically to another optical fiber, it is necessary to design the cross-sectional shape according to the optical fiber to which the resulting optical fiber is to be connected. Thus, this approach is unsuitable for practical use.

### BRIEF SUMMARY OF THE INVENTION

According to an aspect of the present invention, there is provided a semiconductor laser apparatus comprising a semiconductor laser, optical means for converting rays of light emitted from the semiconductor laser into parallel rays of light, and an optical fiber having an incidence end, to which the light passed through the optical means enters, and being changed continuously from a specific position in a middle of the fiber toward the incidence end in such a manner that the core shape at the incidence end becomes elliptic, with the cross-sectional area remaining unchanged.

According to another aspect of the present invention, there is provided a semiconductor laser control method comprising a step of converting rays of light emitted from a semiconductor laser into parallel rays of light, and a step of causing the converted rays of light to enter an optical fiber changed continuously from a specific position in the middle toward an incidence end in such a manner that the core shape at the incidence end becomes elliptic, with the cross-sectional area remaining unchanged.

According to still another aspect of the present invention, there is provided an image displaying apparatus comprising a semiconductor laser apparatus including optical means for converting rays of light emitted from a semiconductor laser into parallel rays of light, and a first optical fiber having an incidence end, to which the light passed through the optical means enters, and being changed continuously from a specific position in the middle toward the incidence end in such a manner that the core shape at the incidence end becomes elliptic, with the cross-sectional area remaining unchanged, a second optical fiber which excites the light emitted from the first optical fiber of the semiconductor laser apparatus, modulation means for modulating spatially the light exited by the second optical fiber, on the basis of an image signal, and display means for projecting the optical output obtained from the modulation means on a screen to display the output.

### BRIEF DESCRIPTION OF THE SEVERAL VIEWS OF THE DRAWING

FIG. 1 is a diagram to help explain a first embedment of the present invention;

FIG. 2 is a diagram to help explain a second embedment of the present invention;

FIG. 3 is a diagram to help explain a third embedment of the present invention;

FIG. 4 is a diagram to help explain a fourth embedment of the present invention;

FIGS. 5A to 5D are diagrams to help explain the main part of the fourth embodiment in detail;

FIG. 6 is a diagram to help explain a fifth embedment of the present invention; and

FIG. 7 is a diagram to help explain a sixth embedment of the present invention.

### DETAILED DESCRIPTION OF THE INVENTION

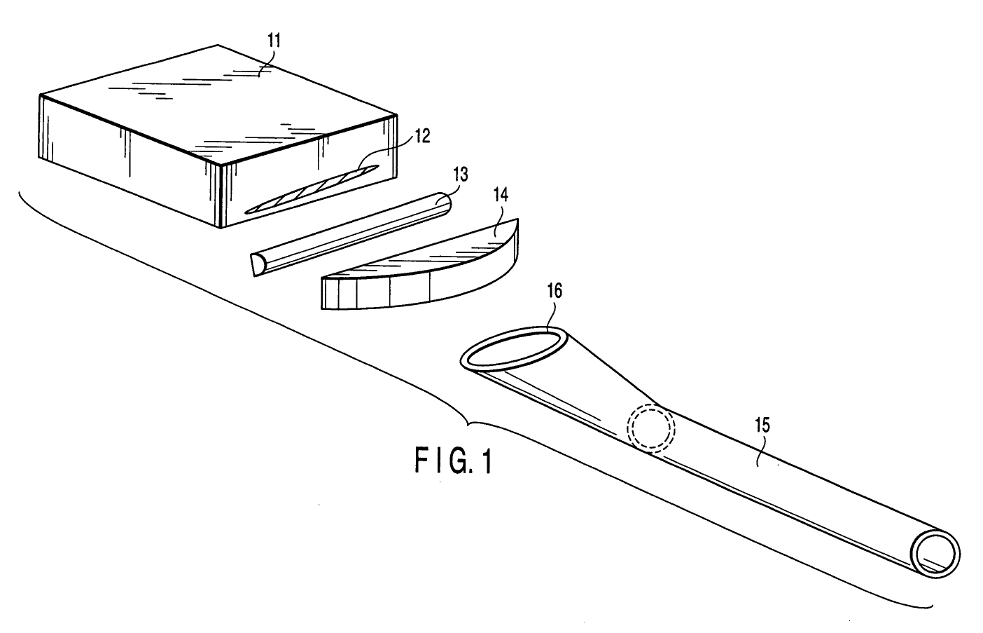

Hereinafter, referring to the accompanying drawings, embodiments of the present invention will be explained in detail. FIG. 1 is a schematic diagram of a semiconductor laser apparatus to be explained in a first embodiment of the present invention. In FIG. 1, numeral 11 indicates a semiconductor laser. A long, narrow emitting region 12 is formed at one end of the semiconductor laser 11.

The light emitted from the emitting region 12 of the semiconductor laser 11 is collimated in the fast axis direction by a cylindrical lens 13. The collimated light is further collimated in the slow axis direction by a cylindrical lens 14 and then enters an optical fiber 15.

An incidence end part (fiber end portion) 16 of the optical fiber 15 is changed continuously into a tapered form in such a manner that the part is pressed or crushed gradually along the diameter from a specific position in the middle toward the end (like a tapered figure) so that the core cross section may take the form of an ellipse (which could be a warped ellipse, defective circle, or round-edge plate), with the cross-sectional area remaining unchanged.

For example, when the core cross-sectional shape of the incidence end part 16 is 20×5 μm, the taper length is 10 mm. When the core cross-sectional shape of the incidence end part 16 is 40×10 μm, the taper length is 20 mm.

The cylindrical lenses 13, 14 are so designed that an emitting region 12 of the semiconductor laser 11 and the core cross-sectional shape of the incidence end part 16 of the optical fiber 15 (or the shape of an exterior side of the fiber end portion) have a conjugate relationship with each other.

Here, the core cross-sectional shape of the incidence end part 16 will be explained. Let the length of the emitting region 12 of the semiconductor laser 11 in the slow axis direction be Dslow_LD and the length of the emitting region 12 in the fast axis direction be Dfast_LD. Additionally, let the divergence angle of the emitted light from the semiconductor laser 11 be Oslow_LD in the slow axis direction and Ofast_LD in the fast axis direction.

Furthermore, let the beam diameter on the incidence end part 16 of the optical fiber 15 be Dslow_FB in the slow axis direction and Dfast_FB in the fast axis direction. Let the divergence angle be Oslow_FB in the slow axis angle and θfast_FB in the fast axis angle.

Then, under sine conditions, the following equations hold:

Dslow_{—}LD·sin(θslow_{—}LD)=Dslow_{—}FB·sin(θslow_{—}FB) (1)

θfast_{—}LD·sin(θfast_{—}LD)=Dfast_{—}FB·sin(θfast_{—}FB) (2)

Since the light-receiving angle of the optical fiber 15 is symmetric with respect to the optical axis, it is desirable that the divergence angle of the light emitted from the semiconductor laser 11 should be symmetric with respect to the optical axis at the time when the light enters the optical fiber 15.

When the incidence end part 16 converts the divergence angle by use of the cylindrical lenses 13, 14 so that the divergence angle in the slow axis direction may become equal to the divergence angle in the fast axis angle, since θslow_FB=θfast_FB, the ratio of the beam diameter at the incidence end part 16 in the slow axis direction to that in the fast axis direction is expressed as:

Dslow_{—}FB/Dfast_{—}FB=[Dslow_{—}LD·sin(θslow_{—}LD)]/[Dfast_{—}LD·sin(θfast_{—}LD)] (3)

It is desirable that the major axis/minor axis ratio of the ellipse at the core cross section is set according to equation (3).

To cause the emitted light from the semiconductor laser 11 to enter the optical fiber with as high a light density as possible, the cross-sectional shape of the core cross section has only to be determined using equations (1) and (2), provided that θslow_FB=θfast_FB=the maximum light-receiving angle of the optical fiber.

The optical fiber 15 is such that the core cross section changes continuously from an ellipse to a regular circle, starting from the incidence end part 16 toward the inner part. Consequently, when the light entering the incidence end part 16 advances in the optical fiber 15, as the shape of the light gets closer to a regular circle along the major axis of the ellipse, the diameter of the light decreases, with the result that the divergence angle tends to become larger. As the shape of the light gets closer to a regular circle along the minor axis of the ellipse, the diameter of the light increases, with the result that the divergence angle tends to become smaller.

However, in the optical fiber 15, the side of the core is inclined with respect to the major and minor axes of the ellipse. Therefore, when light is reflected in the core a plurality of times, this causes the tendency of the divergence angle to increase and the tendency of the divergent angle to decrease to offset each other, with the result that the divergence angle remains unchanged if the area of the ellipse and that of the regular circle are constant.

This enables the beam diameter to be converted from an ellipse to a regular circle with the divergence angle of light remaining unchanged. This effect makes it possible to cause the light emitted from the semiconductor laser 11 to enter the optical fiber 15 with a circular core cross section at high efficiency with high light density.

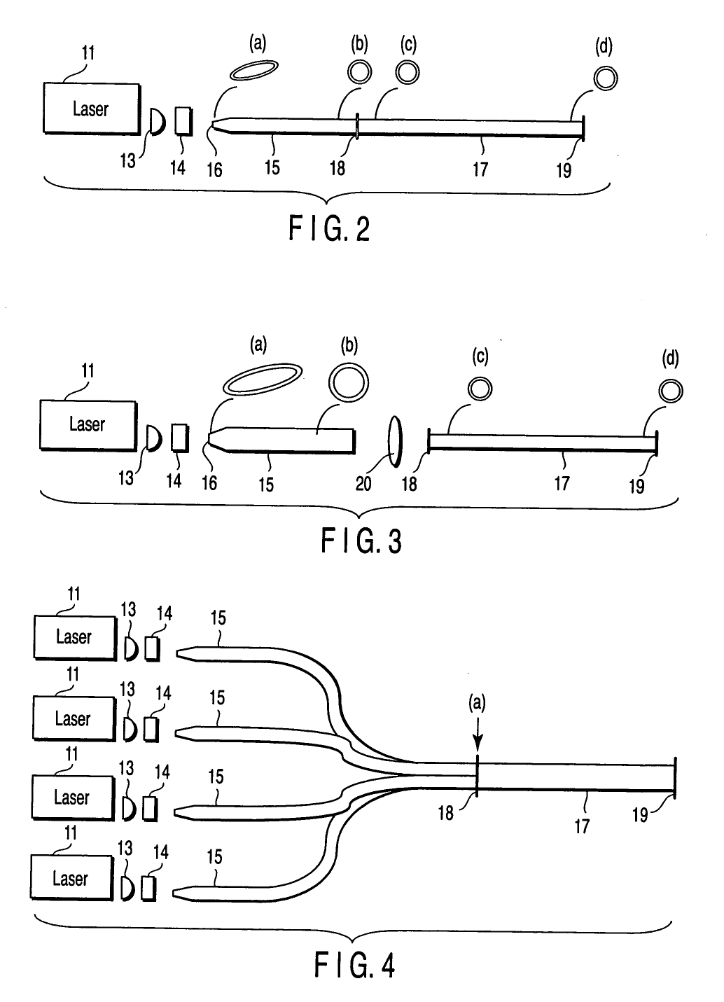

FIG. 2 shows a second embodiment of the present invention. In FIG. 2, the same parts as those in FIG. 1 are indicated by the same reference numerals. In the second embodiment, the semiconductor laser apparatus explained in the first embodiment is used to input excitation light to an optical fiber laser.

In FIG. 2, numeral 17 indicates an optical fiber to whose core a laser activating material is added, numeral 18 indicates a reflecting element that permits the light (excitation light) emitted from the semiconductor laser 11 to pass through and reflects the laser light generated at the optical fiber 17, and numeral 19 indicates a reflecting element that reflects part of the laser light generated at the optical fiber 17. In FIG. 2, (a) to (d) show cross-sectional shapes in various places of the optical fibers 15, 17.

Specifically, for example, the wavelength of the semiconductor laser 11 is 830 to 850 nm. The laser activating material in the core of the optical fiber 17 may be Pr³+/Yb³+. The reflecting element 18 permits all the light with a wavelength of 830 to 850 nm to pass through and reflects all the light with a wavelength of 635 nm. The reflecting element 19 reflects part of the light with a wavelength of 35 nm.

The excitation light with a wavelength of 830 to 850 nm emitted from the semiconductor laser 11 passes through the cylindrical lenses 13, 14 and the optical fiber 15 and enters the optical fiber 17. The excitation light is absorbed by Pr³⁺/Yb³⁺ in the optical fiber 17, thereby generating light with a wavelength of 635 nm.

From the generated light with a wavelength of 635 nm, a resonator provided between the reflecting elements 18 and 19 produces laser light with a wavelength of 635 nm and outputs the laser light at the reflecting element 19. The excitation light of the optical fiber laser requires a high output and a high light density. Use of the semiconductor laser apparatus of the first embodiment enables the optical fiber laser to be realized.

FIG. 3 shows a third embodiment of the present invention. In FIG. 3, the same parts as those in FIG. 2 are indicated by the same reference numerals. The third embodiment differs from the second embodiment in that the core diameter of the optical fiber 15 whose incidence end part 16 is formed into an ellipse differs from the core diameter of the optical fiber 17 to which a laser activating material is added.

As for the optical fiber 15, it is desirable that the core diameter should be determined on the basis of the facility for forming an ellipse. For example, use of a plastic fiber as the optical fiber 15 enables the plastic fiber to be flattened (or made substantially elliptic) by applying pressure to the plastic fiber, while heating the ends of the plastic fiber.

The core diameter of the plastic fiber is generally 100 μm or more. On the other hand, the core diameter of the optical fiber 17 to which a laser activating material is added is several hundred micrometers to several micrometers, depending on the application.

Therefore, both of core diameters do not necessarily coincide with each other. Therefore, in the third embodiment, after the optical fiber 15 changes the beam shape from an ellipse to a regular circle, the core diameter of the optical fiber 15 is converted into the core diameter of the optical fiber 17 by use of the lens 20.

Here, the elliptic core of the incidence end part 16 of the optical fiber 15 is designed so that the major axis/minor axis ratio may satisfy equation (3). At the same time, the cylindrical lenses 13, 14 are set so that the shape of the emitting region 12 of the semiconductor laser 11 and the elliptic cross shape of the incidence end part 16 of the optical fiber 15 may have a conjugate relationship with each other.

Since the operation of the optical fiber laser in the third embodiment is the same as in the second embodiment, its explanation will be omitted. Conversion means for converting the core diameter is not limited to lens 20. For instance, a taper fiber whose core diameter changes continuously or other optical means may be used.

FIG. 4 shows a fourth embodiment of the present invention. In FIG. 4, the same parts as those in FIG. 2 are indicated by the same reference numerals. The fourth embodiment differs from the second embodiment in that a plurality of semiconductor laser apparatuses (four semiconductor laser apparatuses in FIG. 4) are arranged in parallel and the individual optical fibers 15 are bundled together and then light is caused to enter the optical fiber 17 to which a laser activating material is added.

When an output higher than the output of the laser light obtained by the optical fiber laser shown in the second embodiment is needed, arranging more than one configuration of the second embodiment as they are requires a plurality of optical fibers 17 and a plurality of reflecting elements 18, 19.

Furthermore, when the output of the optical fiber laser is connected optically to another optical fiber, a plurality of optical fibers to be connected are needed, leading to an increase in the cost. To avoid this problem, a plurality of optical fibers 15 bundled together are connected optically to the optical fiber 17, thereby reducing the cost.

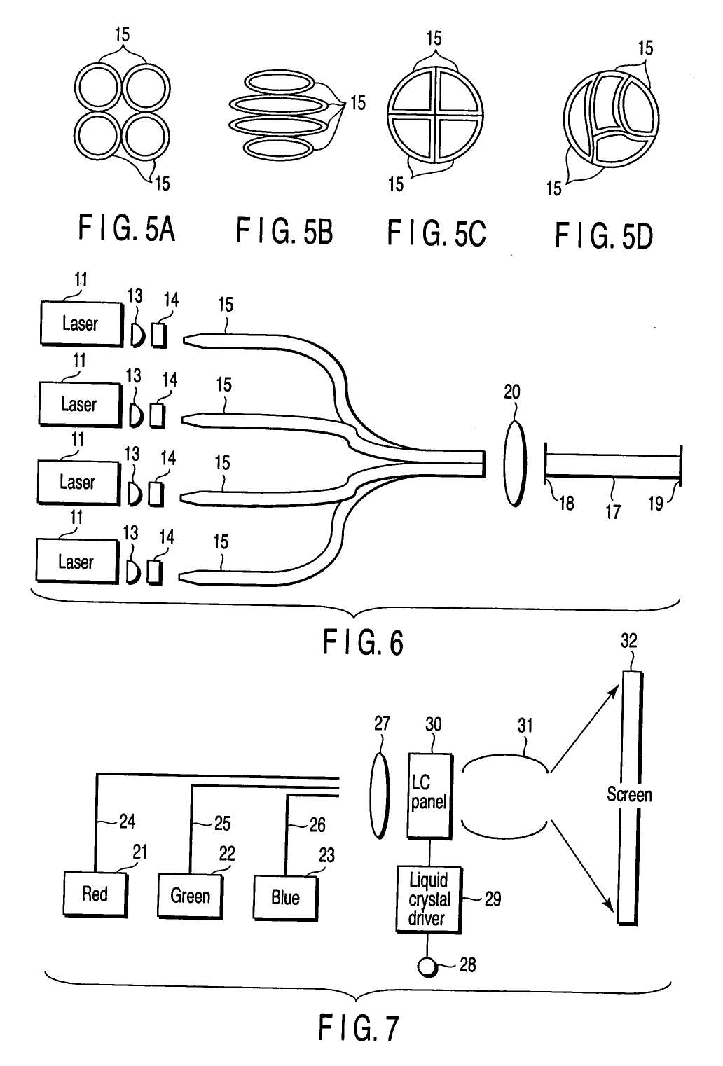

FIGS. 5A to 5D are sectional views of the portion indicated by (a) in FIG. 4. To bundle the optical fibers 15 together with a high light density, it is desirable that the optical fibers 15 should have a less thickness.

Furthermore, in addition to just bundling the optical fibers 15 together, it is desirable that the end portions of the optical fibers 15 should be so processed that the cores contact each other closely as shown in FIGS. 5B to 5D and have the same shape as the core cross-sectional shape of the optical fiber 17.

The cross-sectional shape of each optical fiber 15 in the close contact has to change continuously from a regular circle to any one of the shapes in FIGS. 5B to 5D, with the area remaining unchanged. Since the cross sections of the optical fibers 15 are not necessarily shaped as shown in FIG. 5B or 5C but only the external form of the optical fibers 15 has to be shaped as shown in FIG. 5D, it is easy to process the optical fibers 15.

Since the processed part and the unprocessed part change continuously, with the core cross-sectional area remaining unchanged, the divergence angle of light does not change, which enables optical connection to the optical fiber 17, while retaining the high efficiency and high light density.

FIG. 6 shows a fifth embodiment of the present invention. In FIG. 6, the same parts as those in FIG. 3 are indicated by the same reference numerals. The fifth embodiment is a combination of the third and fourth embodiments. In the fifth embodiment, the difference between the core diameter of the bundled optical fibers 15 and the core diameter of the optical fiber 17 to which a laser activating material is added is corrected by the lens 20.

In the explanation of the above embodiments, when the incidence end part 16 of the optical fiber 15 is processed, the area of the processed part and the area of the unprocessed part are made constant. A vital part of the explanation is the conversion of the beam shape.

Specifically, when the area is constant, the divergence angle is constant at both of the processed part and the unprocessed part. When the area is not constant, the divergent angle changes in inverse proportion to the area ratio of the processed part to the unprocessed part. Therefore, when the divergence angle is required to change, or the area is also needed to change, the area at the processed part may be made different from that at the unprocessed part.

FIG. 7 shows the configuration of an image displaying apparatus according to a sixth embodiment of the present invention. In the sixth embodiment, the optical fiber laser in one of the second to fifth embodiments is used as a light source for a projection-type image displaying apparatus.

In FIG. 7, numerals 21, 22, 23 indicate optical fiber lasers. In the optical fiber lasers 21 to 23, a laser activating material to be added to the optical fiber 17, the oscillation wavelength of the semi-conductor laser 11, and others are set so that red, green, and blue laser lights may be obtained by wavelength up-conversion.

Furthermore, numerals 24, 25, 26 indicate optical fibers that output laser light generated at the optical fibers 21, 22, 23, respectively. Numeral 27 indicates a lens, 28 an image input terminal, 29 a liquid-crystal driver, 30 a liquid-crystal panel, 31 a projection lens, and 32 a screen.

The operation of the image displaying apparatus will be explained. The rays of light emitted from the ends of the optical fibers 24 to 26 become parallel rays at the lend 27, which causes the parallel rays to enter the liquid-crystal panel 30.

On the other hand, an image signal is inputted from the image input terminal 28. On the basis of the image signal, the liquid-crystal driver 29 drives the liquid-crystal panel 30. As a result, the light being entered into the liquid-crystal panel 30 is spatially-modulated according to the image signal.

The spatially modulated light forms an image via the projection lens 31 on the screen 32. Red, green, and blue rays of light of about several watts are needed for the light source of the projection-type image displaying apparatus. Use of the optical fiber laser shown in any one of the second to fifth embodiments enables such a light source to be realized at a low cost.

As described above, only the end part of the optical fiber 15 is deformed continuously, thereby converting the beam shape arbitrarily. When the processed part and the unprocessed part are constant in area, the divergence angle of light remains unchanged at both of the parts.

With the feature, forming the incidence end part 16 of the optical fiber 15 into an ellipse makes it possible to cause the light emitted from the semi-conductor laser 11 to enter the optical fiber 15 at a high efficiency with a high light density. In addition, the output can be connected optically to an ordinary optical fiber whose core cross section is round.

Furthermore, when a plurality of optical fibers 15 are bundled together and connected to one optical fiber 17, the end part of the optical fibers 15 bundled together is so processed that the external form cross section of the bundled optical fibers 15 has the same shape as that of the cross section of the optical fiber 17, which realizes optical connection between them at a high efficiency with a high light density.

Moreover, making use of this feature, it is possible to configure an optical fiber laser using the semiconductor laser 11 for excitation light, generate red, green, and blue rays of light of high output by wavelength up-conversion with the optical fiber laser, and use the optical fiber laser as a light source for the projection-type image displaying apparatus.

With the above configuration and method, the light emitted from the semiconductor laser is caused to enter a first optical fiber changed continuously from a specific position in the middle toward the incidence end in such a manner that the core shape at the incidence end becomes substantially elliptic, with the cross section remaining substantially unchanged. This enables the emitted light from the semiconductor laser to enter the optical fiber easily at a high efficiency with a high light density by use of a simple configuration. As a result, a highly efficient light source is realized, which enables the image displaying apparatus to consume less power and reduces the manufacturing cost.

While the description above refers to particular embodiments of the present invention, it will be understood that many modifications may be made without departing from the spirit thereof. The accompanying claims are intended to cover such modifications as would fall within the true scope and spirit of the present invention. The presently disclosed embodiments are therefore to be considered in all respects as illustrative and not restrictive, the scope of the invention being indicated by the appended claims, rather than the foregoing description, and all changes that come within the meaning and range of equivalency of the claims are therefore intended to be embraced therein.

As described in detail, with the present invention, it is possible to provide a semiconductor laser apparatus and a semiconductor laser control method which enable the light emitted from a semiconductor laser to enter an optical fiber easily at a high efficiency with a high light density by use of a simple configuration. Furthermore, according to the present invention, an image displaying apparatus using the semiconductor laser apparatus can be provided.

What is claimed is:

1. A laser apparatus comprising:
a laser unit configured to emit laser light;
an optical member configured to convert the laser light emitted from said laser unit into parallel light rays; and
an optical fiber having a core with a predetermined cross-sectional shape, and being provided with a fiber end portion, said fiber end portion having an exterior side configured to receive the light rays from said optical member, and having an interior side being continued to the core of said optical fiber,
the interior side of said fiber end portion being configured to have a given shape with a first area,
the exterior side of said fiber end portion being configured to have substantially an elliptical shape with a second area of which amount is substantially equal to an amount of the first area of said interior side, and
the given shape at the interior side of said fiber end portion changing continuously to the elliptical shape at the exterior side of said fiber end portion.

2. The apparatus of claim 1, wherein said fiber end portion is obtained by pressing or crushing an end portion of said optical fiber such that a degree of the pressing or crushing along a diameter direction of the optical fiber becomes gradually greater from a position of the interior side toward a position of the exterior side.

3. The apparatus of claim 1, wherein said laser unit has a laser emitting region from which the laser light is emitted, and said optical member is configured such that the laser emitting region is conjugate with a shape the exterior side of said fiber end portion.

4. The apparatus of claim 1, wherein
said laser unit has a laser emitting region from which the laser light is emitted, the laser emitting region having a length of Dslow_LD along a slow axis direction thereof and having a length of Dfast_LD along a fast axis direction thereof,
the laser light emitted from said laser unit has a divergence angle θslow_LD along the slow axis direction and a divergence angle θfast_LD along the fast axis direction, and
the elliptical shape of said fiber end portion has its manor axis/minor axis ratio defined as:
Dslow_{—}LD*sin(θslow_{—}LD)/Dfast_{—}LD*sin(θfast_{—}LD).

5. The apparatus of claim 1, further comprising a second optical fiber having a core to which a laser activating material is added, said second optical fiber having an end face for receiving the laser light passing through said optical fiber.

6. The apparatus of claim 5, further comprising an optical device configured to convert the laser light, passing through said optical fiber, into other laser light being matched with a size of the core of said second optical fiber, where the core size of said second optical fiber differs from that of said optical fiber.

7. The apparatus of claim 1, wherein said laser unit includes a plurality of laser unit members, and said optical fiber includes a plurality of optical fiber members having end portions configured to respectively receive light rays from said laser unit members, said apparatus further comprising
a second optical fiber having a core with a given cross-sectional shape, and having an end face for receiving the light rays passing through said optical fiber members, the end face of said second optical fiber being matched with a gathered end face of said optical fiber members from which the light rays are output.

8. The apparatus of claim 7, further comprising an optical device configured to convert the light rays, passing through said optical fiber members, into light being matched with a size of the core of said second optical fiber where the core size of said second optical fiber differs from the gathered end face of said optical fiber members.

9. A method of handling laser light comprising
converting laser light, emitted from a semiconductor laser device, into parallel light rays; and
inputting the converted parallel light rays into an incidence end face of an optical fiber wherein
said optical fiber includes an end portion having the incidence end face, and
the incidence end face is obtained by changing a cross-section of the end portion into a substantially elliptical shape while keeping an area of the cross-section to be constant.

10. The method of claim 9, further comprising
inputting the laser light, passing through the optical fiber, into a second optical fiber having a core to which a laser activating material is added.

11. The method of claim 10, further comprising converting the laser light, passing through the optical fiber, into other laser light to be input to the second optical fiber such that the converted other laser light is matched with a core size of the second optical fiber, where the core size of said second optical fiber differs from that of said optical fiber.

12. An image display apparatus for use with a screen comprising:
(a) a laser apparatus including
a laser unit configured to emit laser light, and
a first optical fiber having a core with a predetermined cross-sectional shape, and being provided with an incidence end face for receiving the laser light wherein the incidence end face is obtained by changing a cross-section of the first optical fiber into a substantially elliptical shape while keeping an area of the cross-section to be constant;
(b) a second optical fiber configured to excite the laser light passing through said first optical fiber;
(c) a modulator configured to spatially modulate the laser light excited by said second optical fiber; and
(d) an optical projection unit configured to receive the laser light being spatially-modulated by said modulator and to output the received spatially-modulated laser light toward the screen.

13. The apparatus of claim 9, wherein said laser apparatus includes a plurality of laser units respectively configured to emit laser light rays, and a plurality of first optical fibers each having a core with a predetermined cross-sectional shape, respectively having one ends for receiving the laser light rays from the laser units, and respectively having other ends for outputting the laser light rays passing through the first optical fibers,
wherein said second optical fiber has a core with a given cross-sectional shape, and having an end face for receiving the laser light rays passing through said first optical fibers, the end face of said second optical fiber being matched with a gathered end face of the other ends of said first optical fibers from which the laser light rays are output,
wherein said modulator is configured to spatially modulate the laser light passing through said second optical fiber, and
wherein said optical projection unit is configured to output the spatially-modulated laser light toward the screen.
